(19) United States
(12) Patent Application Publication
(10) Pub. No.: US 2026/0225864 A1
(43) Pub. Date: Aug. 6, 2026

(54) CRANE ATTACHMENT

(71) Applicant: KOBELCO CONSTRUCTION MACHINERY CO., LTD., Hiroshima-shi (JP)

(72) Inventors: Koji SUMIMOTO, Hyogo (JP); Kenichi NAKATSUKA, Hyogo (JP)

(73) Assignee: KOBELCO CONSTRUCTION MACHINERY CO., LTD., Hiroshima-shi (JP)

(21) Appl. No.: 18/703,943

(22) PCT Filed: Oct. 19, 2022
(86) PCT No.: PCT/JP2022/038917

§ 371 Date: Apr. 16, 2026

(30) Foreign Application Priority Data
Oct. 27, 2021 (JP) 2021-175487

(51) Int. Cl. B66C 23/70; B66C 23/42; B66C 23/82

(52) U.S. Cl. CPC B66C 23/70; B66C 23/42; B66C 23/823; B66C 2700/0371

(57) ABSTRACT

A crane attachment includes a jib support device that supports, from rear, a jib that takes a forward tilted posture with respect to a boom when the boom takes a raised posture. The jib support device includes a link restraint tool configured to be capable of restraining a jib support line connecting link in a jib support line connecting link fixed posture that is a predetermined rotation posture with respect to a strut distal end portion and of restraining a strut support line connecting link in a strut support line connecting link fixed posture that is a predetermined rotation posture with respect to the strut distal end portion.

### TECHNICAL FIELD

The present invention relates to a crane attachment.

### BACKGROUND ART

Conventionally, there has been known a crane attachment for performing crane work of hanging a suspended load by being attached to a crane body. For example, Patent Literature 1 below discloses an example of such a crane attachment.

Specifically, the crane attachment disclosed in Patent Literature 1 below includes a boom attached to an upper slewing body as a crane body so as to be raised and lowered, a fixed jib having a jib proximal end portion attached to the distal end portion of the boom so as to be rotatable about an axis extending in the width direction of the boom, a strut having a strut proximal end portion attached to the distal end portion of the boom so as to be rotatable about an axis extending in the width direction of the boom and extending from the distal end portion of the boom toward the back thereof, a guy line linearly stretched between the distal end portion of the fixed jib and the distal end portion of the strut, and another guy line linearly stretched between the distal end portion of the strut and an intermediate portion of the boom in the extending direction thereof. In this crane attachment, the strut and the two guy lines support the fixed jib in a forward tilted posture with respect to the raised boom from the back of the fixed jib to fix the fixed jib in the forward tilted posture.

Meanwhile, the distal end portion of the strut generally includes a jib support line connecting link for connecting an end portion of a jib support guy line stretched between the distal end portion of the jib and the distal end portion of the strut to the distal end portion of the strut and a strut support line connecting link for connecting an end portion of a strut support guy line stretched between the distal end portion of the strut and an intermediate portion of the boom to the distal end portion of the strut. The jib support line connecting link and the strut support line connecting link are attached to the distal end portion of the strut so as to be rotatable about an axis extending in parallel with the rotation axis of the strut proximal end portion.

However, since the jib support line connecting link and the strut support line connecting link are rotatable, during the disassembly, transportation, and assembly of the crane, the jib support line connecting link and/or the strut support line connecting link may be damaged or the workability of attaching and detaching the jib support guy line to and from the jib support line connecting link and attaching and detaching the strut support guy line to and from the strut support line connecting link may be degraded.

Specifically, when the crane is transferred, the crane is disassembled, loaded on a transport vehicle such as a trailer and transported for each certain structural unit, and the transported structural units are assembled at a transport destination to assemble the crane. If the jib support line connecting link and the strut support line connecting link are rotatable with respect to the distal end portion of the strut, during the disassembly, transportation, and assembly of such a crane, the jib support line connecting link and/or the strut support line connecting link may unintentionally rotate and collide with a surrounding member or the like, and the jib support line connecting link and/or the strut support line connecting link may be damaged.

In addition, if the jib support line connecting link is rotatable with respect to the distal end portion of the strut, the jib support line connecting link moves when the jib support line is attached to and detached from the jib support line connecting link, and it is difficult to perform the attachment and detachment work. Similarly, if the strut support line connecting link is rotatable with respect to the distal end portion of the strut, the strut support line connecting link moves when the strut support line is attached to and detached from the strut support line connecting link, and it is difficult to perform the attachment and detachment work.

### CITATION LIST

### Patent Literature

Patent Literature 1: JP 2012-162344 A

### SUMMARY OF INVENTION

An object of the present invention is to provide a crane attachment capable of preventing a jib support line connecting link and a strut support line connecting link from being damaged during the disassembly, assembly, and transportation of a crane, and capable of improving the workability of attaching and detaching a jib support line to and from the jib support line connecting link and attaching and detaching a strut support line to and from the strut support line connecting link.

Provided by the present invention is a crane attachment for performing crane work of hanging a suspended load by being attached to a crane body. The crane attachment includes a boom that has a boom proximal end portion attached to the crane body and a boom distal end portion that is an end portion opposite to the boom proximal end portion, a jib that has a jib proximal end portion that is one end portion rotatable about an axis extending in a width direction of the boom with respect to the boom distal end portion and separably attached to the boom distal end portion, and a jib distal end portion that is an end portion opposite to the jib proximal end portion, and a jib support device that supports, from rear, the jib that takes a forward tilted posture with respect to the boom when the boom proximal end portion is attached to the crane body and the boom takes a raised posture. The jib support device includes a jib support line that has a jib support line one end portion that is an end portion connected to the jib distal end portion and a jib support line other end portion that is an end portion opposite to the jib support line one end portion, a strut that is attached to an attached portion that is one of the jib proximal end portion or the boom distal end portion, is disposed in a posture extending from the attached portion to back of the attached portion when the jib takes the forward tilted posture, and supports the jib support line other end portion at a position away from the attached portion to the back of the attached portion so as to cause the jib support line to extend from the jib distal end portion and be stretched, and a strut support line that has a strut support line one end portion connected to the strut and keeps the strut from falling down in a direction along the jib. The strut includes a strut body that has a strut proximal end portion that is one end portion attached to the attached portion so as to be rotatable about an axis parallel to a rotation axis of the jib proximal end portion and a strut distal end portion that is an end portion opposite to the strut proximal end portion, a jib support line connecting link that is attached to the strut distal end portion so as to be rotatable about an axis parallel to a rotation axis of the strut proximal end portion and to which the jib support line other end portion is connected, and a strut support line connecting link that is attached to the strut distal end portion so as to be rotatable about an axis parallel to the rotation axis of the strut proximal end portion and to which the strut support line one end portion is connected. The jib support device further includes a link restraint tool configured to be capable of restraining the jib support line connecting link in a jib support line connecting link fixed posture that is a predetermined rotation posture with respect to the strut distal end portion and restraining the strut support line connecting link in a strut support line connecting link fixed posture that is a predetermined rotation posture with respect to the strut distal end portion.

### BRIEF DESCRIPTION OF DRAWINGS

FIG. 1 is a side view of a crane to which a crane attachment according to an embodiment of the present invention is applied.

FIG. 2 is a partially enlarged view of a strut distal end portion, a jib support line connecting link and a strut support line connecting link, and guy lines connected to these links in the crane attachment illustrated in FIG. 1.

FIG. 3 is a side view illustrating a state where a lower jib member of a jib for the crane attachment is separated and a strut is disposed on the lower jib member in a storage posture, and is a diagram illustrating a state where a jib support line is connected to the jib support line connecting link and a strut support line is connected to the strut support line connecting link.

FIG. 4 is a diagram of the lower jib member and the strut illustrated in FIG. 3 as viewed from a direction IV in FIG. 3.

FIG. 5 is a diagram illustrating a state before the rotation posture of the jib support line connecting link is restrained.

FIG. 6 is a diagram illustrating a state where the strut support line connecting link is disposed in a strut support line connecting link fixed posture and the jib support line connecting link is disposed in a jib support line connecting link fixed posture and restrained in these fixed postures.

FIG. 7 is a cross-sectional view of the strut support line connecting link and the jib support line connecting link, and the strut in a state where the links are arranged in their fixed postures.

FIG. 8 is a side view of the jib support line connecting link.

FIG. 9 is a perspective view of the jib support line connecting link.

FIG. 10 is a side view of the strut support line connecting link.

FIG. 11 is a perspective view of the strut support line connecting link.

FIG. 12 is a diagram illustrating a process of assembling the crane attachment, and is a diagram illustrating a state where a jib proximal end portion is coupled to a boom distal end portion.

FIG. 13 is a diagram illustrating a state where the strut is raised from the state illustrated in FIG. 12.

### DESCRIPTION OF EMBODIMENTS

An embodiment of the present invention will be described below with reference to the drawings.

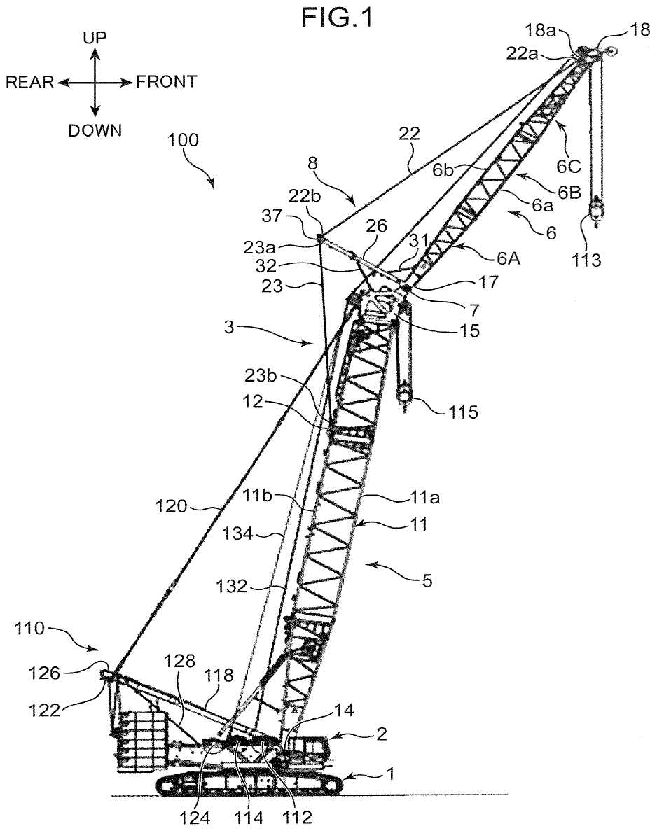

A crane attachment 3 according to an embodiment of the present invention is applied to a crane 100 illustrated in FIG. 1 to perform crane work of hanging a suspended load. The crane 100 includes a travelling body 1 capable of self-propelling, a slewing body 2 slewably mounted on the travelling body 1, and the crane attachment 3. The slewing body 2 is an example of a crane body according to the present invention.

The crane attachment 3 according to the present embodiment is separably attached to the slewing body 2. The crane attachment 3 includes a boom 5, a jib 6, a pair of jib coupling pins 7, a jib support device 8, and a pair of support pins 9.

The boom 5 is attached to the slewing body 2 so as to be raised and lowered. The boom 5 includes a boom body 11 with a linearly extending lattice structure and a boom-side line coupling portion 12 attached to the boom body 11.

The boom body 11 has a boom proximal end portion 14 that is one end portion in an extending direction thereof and a boom distal end portion 15 that is the end portion opposite to the boom proximal end portion 14. The boom proximal end portion 14 is attached to the slewing body 2 so as to be rotatable about a rotation axis extending in the left-right direction of the slewing body 2 (the width direction of the boom 5). By attaching the boom proximal end portion 14 to the slewing body 2 in this manner, the boom 5 can be raised and lowered with the rotation axis of the boom proximal end portion 14 as a fulcrum. The boom proximal end portion 14 is attachable to and detachable from the slewing body 2.

As illustrated in FIG. 1, the boom body 11 has a boom front surface 11a facing forward in a state where the boom 5 is raised, and a boom back surface 11b facing rearward in this state.

The boom front surface 11a faces downward when the boom 5 is laid down, and the boom back surface 11b faces upward when the boom 5 is laid down.

The boom-side line coupling portion 12 is a portion to which an end portion of a strut support line 23 to be described later of the jib support device 8 is separably coupled. The boom-side line coupling portion 12 is disposed at a position away from the boom distal end portion 15 toward the boom proximal end portion 14 by a predetermined distance, and is provided on the boom back surface 11b.

The jib 6 has a lattice structure and extends linearly. The jib 6 has a jib proximal end portion 17 that is one end portion in an extending direction thereof and a jib distal end portion 18 that is the end portion opposite to the jib proximal end portion 17. The jib 6 has a plurality of jib members arranged side by side in the extending direction thereof and coupled to each other. Specifically, the jib 6 has a lower jib member 6A including the jib proximal end portion 17, an intermediate jib member 6B, and an upper jib member 6C including the jib distal end portion 18. Note that the jib 6 may include a plurality of intermediate jib members. Furthermore, the intermediate jib member 6B can be omitted.

As illustrated in FIG. 1, the jib 6 has a jib front surface 6a facing forward in a state where the jib is raised together with the boom 5 and a jib back surface 6b facing rearward in this state. The jib front surface 6a faces downward when the jib 6 is laid down, and the jib back surface 6b faces upward when the jib 6 is laid down.

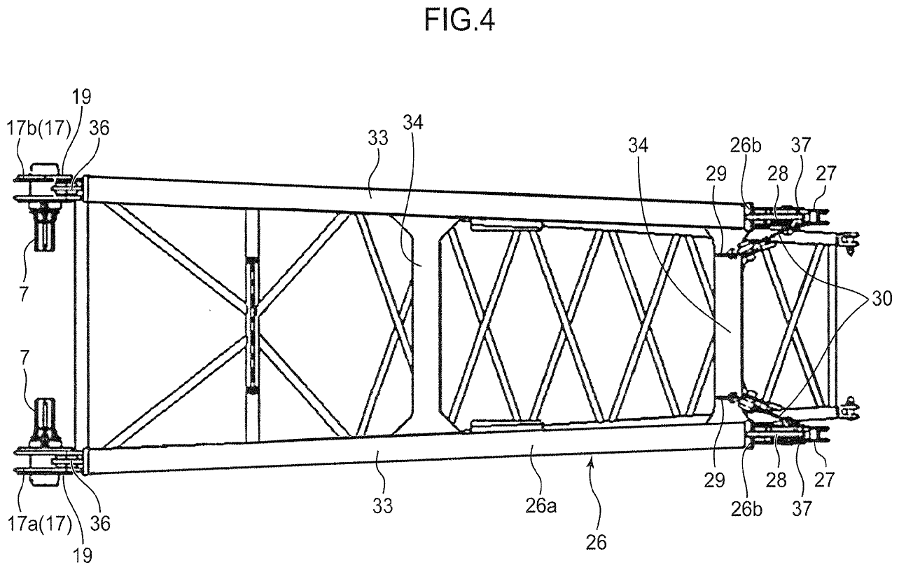

The jib proximal end portion 17 is attached to the boom distal end portion 15 so as to be rotatable about an axis extending in the left-right width direction of the boom 5. That is, the jib proximal end portion 17 is attached to the boom distal end portion 15 so as to be rotatable about an axis parallel to the rotation axis of the boom proximal end portion 14. The jib proximal end portion 17 is attachable to and detachable from the boom distal end portion 15. Specifically, the jib proximal end portion 17 has a jib first proximal end portion 17a and a jib second proximal end portion 17b that are arranged at an interval in the width direction of the jib 6 along the rotation axis of the jib proximal end portion 17 (see FIG. 4). The jib first proximal end portion 17a and the jib second proximal end portion 17b are individually coupled to the boom distal end portion 15 by the corresponding jib coupling pins 7. By removing the corresponding jib coupling pins 7 from the jib first proximal end portion 17a and the jib second proximal end portion 17b, the jib proximal end portion 17 can be separated from the boom distal end portion 15. The jib coupling pin 7 for coupling the jib first proximal end portion 17a to the boom distal end portion 15 and the jib coupling pin 7 for coupling the jib second proximal end portion 17b to the boom distal end portion 15 are coaxially arranged. The jib proximal end portion 17 rotates about these jib coupling pins 7 with respect to the boom distal end portion 15.

In addition, the jib proximal end portion 17 includes a pair of strut support portions 19 that supports a pair of strut proximal end portions 36 to be described later. One strut support portion 19 of the pair of strut support portions 19 is provided so as to project from the jib first proximal end portion 17a to the back thereof, and the other strut support portion 19 of the pair of strut support portions 19 is provided so as to project from the jib second proximal end portion 17b to the back thereof. Each of the pair of strut support portions 19 includes a through hole (not illustrated) through which the support pin 9 is inserted. Each strut support portion 19 supports each of the pair of strut proximal end portions 36 to be described later via the support pin 9 inserted into the through hole.

The jib distal end portion 18 has a jib-side line coupling portion 18a (see FIG. 1) to which one end portion of a jib support line 22 to be described later of the jib support device 8 is separably coupled.

The jib support device 8 supports, from rear, the jib 6 that takes a predetermined forward tilted posture with respect to the boom 5 when the boom proximal end portion 14 is attached to the slewing body 2 and the boom 5 takes a raised posture, thereby holding the forward tilted posture of the jib 6. The jib support device 8 has a pair of jib support lines 22, a pair of strut support lines 23, a plurality of connection pins 24 and 25, a strut 26, a pair of link restraint tools 30, a front stopper 31, and a back stopper 32. Note that the individual drawings (FIGS. 1, 2, 12, and 13) in which the jib support line 22 and the strut support line 23 are illustrated are diagrams from a direction in which the pair of jib support lines 22 appears to overlap and the pair of strut support lines 23 also appears to overlap. Therefore, in these drawings, only one of the pair of jib support lines 22 is illustrated, and only one of the pair of strut support lines 23 is illustrated.

The jib support line 22 and the strut support line 23 are so-called guy lines, guy cables, or guy links.

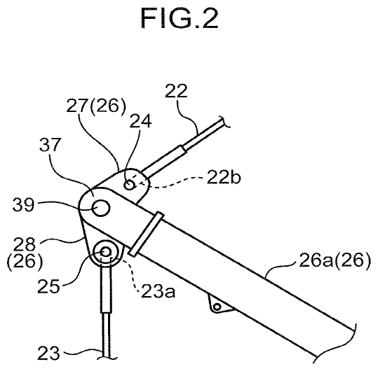

The pair of jib support lines 22 is bridged between the jib distal end portion 18 and a pair of strut distal end portions 37 to be described later, and connects the jib distal end portion 18 and the pair of strut distal end portions 37. Each of the pair of jib support lines 22 has a jib support line one end portion 22a that is one end portion coupled to the jib-side line coupling portion 18a of the jib distal end portion 18, and a jib support line other end portion 22b that is the opposite end portion thereof and is connected to the strut distal end portion 37 via a jib support line connecting link 27 (see FIG. 2) to be described later.

The pair of strut support lines 23 is bridged between the pair of strut distal end portions 37 to be described later and the pair of boom-side line coupling portions 12, connects the pair of strut distal end portions 37 and the pair of boom-side line coupling portions 12, and keeps the strut 26 in a raised posture extending from the jib proximal end portion 17 to the back thereof from falling down in the direction along the jib 6. Each of the pair of strut support lines 23 has a strut support line one end portion 23a connected to the strut distal end portion 37 via a strut support line connecting link 28 (see FIG. 2) to be described later, and a strut support line other end portion 23b that is the opposite end portion thereof and coupled to the boom-side line coupling portion 12 (see FIG. 1).

The strut 26 is attached to the jib proximal end portion 17, which is an attached portion. The strut 26 is disposed in a raised posture extending from the jib proximal end portion 17 to the back thereof when the jib 6 takes the predetermined forward tilted posture. The strut 26 supports the jib support line other end portions 22b of the pair of jib support lines 22 at a position away from the pair of jib proximal end portions 17 in the back thereof in such a manner that the pair of jib support lines 22 linearly extends rearward and obliquely downward from the jib distal end portion 18 and is in a stretched state. The strut 26 supports the jib 6 together with the pair of jib support lines 22 and the pair of strut support lines 23 linearly stretched in this manner in such a manner that the jib takes the predetermined forward tilted posture with respect to the boom 5.

The strut 26 includes a strut body 26a, a pair of jib support line connecting links 27, and a pair of strut support line connecting links 28.

The strut body 26a is attached to the pair of strut support portions 19 of the jib proximal end portion 17 so as to be rotatable about an axis parallel to the rotation axis of the jib proximal end portion 17. The strut body 26a has a pair of strut main columns 33 arranged at an interval in the width direction of the strut body 26a along the rotation axis, and a plurality of beam members 34 connecting the strut main columns 33 between the pair of strut main columns 33. Each of the pair of strut main columns 33 has the strut proximal end portion 36 that is one end portion in the extending direction of the strut main column 33 and the strut distal end portion 37 that is the end portion opposite to the strut proximal end portion 36.

The strut proximal end portion 36 of each of the pair of strut main columns 33 is attached to the corresponding one of the pair of strut support portions 19 of the jib proximal end portion 17 so as to be rotatable about an axis parallel to the rotation axis of the jib proximal end portion 17. Specifically, each strut proximal end portion 36 includes a through hole (not illustrated) through which the support pin 9 is inserted, and each strut proximal end portion 36 is attached to the corresponding strut support portion 19 via the support pin 9 inserted into the through hole and the through hole of the strut support portion 19. Each strut proximal end portion 36 is rotatable with respect to the corresponding strut support portion 19 about the support pin 9 inserted into the through holes.

In addition, the strut proximal end portion 36 of each of the pair of strut main columns 33 is attachable to and detachable from the corresponding one of the pair of strut support portions 19 of the jib proximal end portion 17. Specifically, by extracting the support pin 9 inserted into the through hole of each strut proximal end portion 36 and the through hole of the corresponding strut support portion 19 from these through holes, each strut proximal end portion 36 can be separated from the corresponding strut support portion 19.

The strut distal end portion 37 of each of the pair of strut main columns 33 includes an insertion hole 37a through which a shaft pin 39 is inserted. The jib support line connecting link 27 and the strut support line connecting link 28 are attached to each strut distal end portion 37 via the shaft pin 39.

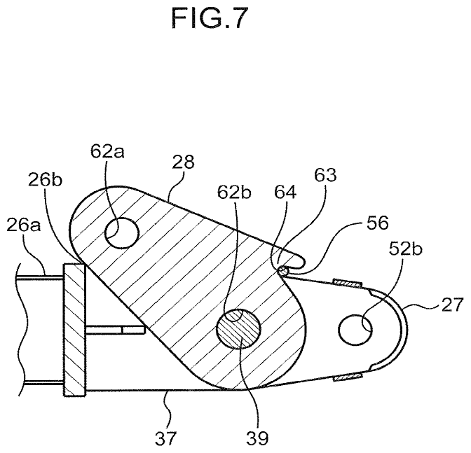

Furthermore, as described later, the strut body 26a includes a pair of link receiving portions 26b (see FIGS. 4 and 7) that receives the pair of strut support line connecting links 28 on the opposite side to a link pressing portion 56 when each of the pair of strut support line connecting links 28 is pressed by the link pressing portion 56 of the corresponding jib support line connecting link 27 and disposed in a strut support line connecting link fixed posture. Each of the pair of link receiving portions 26b is provided at a position on the strut main column 33 between the strut distal end portion 37 and the strut proximal end portion 36 and adjacent to the strut distal end portion 37.

The plurality of beam members 34 are arranged at intervals in the extending direction of the strut main column 33. Each beam member 34 extends in the width direction of the strut body 26a.

In addition, the strut 26 further includes a pair of restraint tool attachment portions 29 to which the pair of link restraint tools 30 is attached. The pair of restraint tool attachment portions 29 is installed at a predetermined position on the strut 26 between the strut distal end portion 37 and the strut proximal end portion 36, and specifically, is installed on the beam member 34 closest to the strut distal end portion 37 among the plurality of beam members 34.

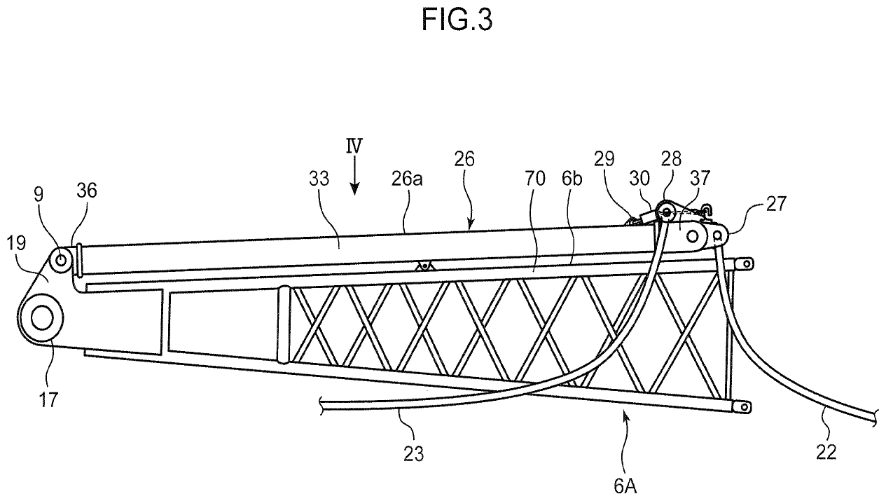

In addition, the strut 26 can take, as a rotation posture around the rotation axis (the support pin 9) of the strut proximal end portion 36, a raised posture (see FIG. 1) in which the strut 26 is raised so as to extend from the jib proximal end portion 17 to the back thereof and a storage posture (see FIG. 3) in which the strut 26 is disposed along the jib back surface 6b of the lower jib member 6A. The strut 26 is transported integrally with the lower jib member 6A when the crane 100 is disassembled and transported, and at that time, is transported in a state of being disposed in the storage posture. Furthermore, when the pair of jib support lines 22 is attached to and detached from the pair of jib support line connecting links 27 and when the pair of strut support lines 23 is attached to and detached from the pair of strut support line connecting links 28, the attachment and detachment also is performed in a state where the strut 26 takes the storage posture.

Each of the pair of jib support line connecting link 27 is attached to the corresponding one of the pair of strut distal end portions 37 so as to be rotatable about an axis parallel to the rotation axis of the strut proximal end portion 36. The jib support line other end portion 22b of each of the pair of jib support lines 22 is separably connected to each of the pair of jib support line connecting links 27.

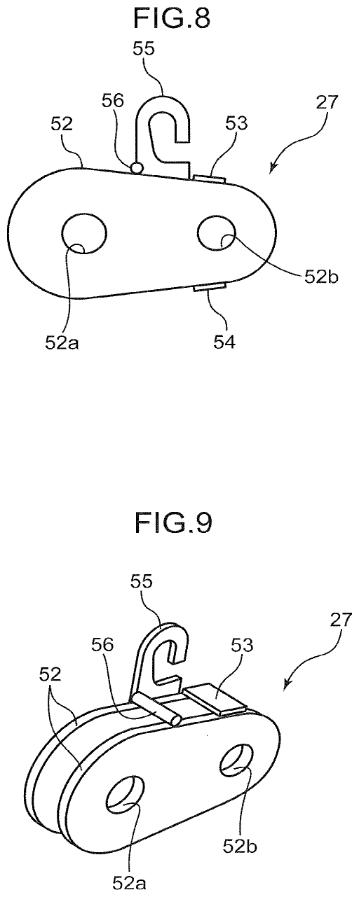

Each jib support line connecting link 27 includes a pair of side plates 52, a one-side bridge portion 53, an other-side bridge portion 54, a locked portion 55, and the link pressing portion 56 (see FIGS. 8 and 9).

The paired side plates 52 are arranged side by side in the direction along the rotation axis of the jib support line connecting link 27. The paired side plates 52 are fixed with a gap between the pair of side plates 52 by the one-side bridge portion 53 bridged on one side edge of the pair of side plates 52 facing one side in the rotation direction of the jib support line connecting link 27 and the other-side bridge portion 54 bridged on the side edge opposite to the one side edge of the pair of side plates 52. Each side plate 52 includes a shaft pin insertion hole 52a and a line connection hole 52b penetrating the side plate 52.

The shaft pin 39 inserted into the insertion hole 37a of the strut distal end portion 37 is inserted into the shaft pin insertion hole 52a of each side plate 52. The pair of side plates 52 is rotatable about the shaft pin 39 with respect to the strut distal end portion 37, so that the jib support line connecting link 27 is rotatable with respect to the strut distal end portion 37.

The line connection hole 52b is a portion to which the jib support line other end portion 22b is connected. Specifically, the connection pin 24 (see FIG. 2) is inserted into the line connection hole 52b, and the jib support line other end portion 22b is connected to the jib support line connecting link 27 via the connection pin 24. The line connection hole 52b is an example of a line connection portion in the present invention.

The locked portion 55 is a portion to which a link-side locking portion 30b of the link restraint tool 30 is locked. The locked portion 55 is fixed to one side plate 52 of the pair of side plates 52. The locked portion 55 projects from one side edge of the side plate 52 facing the rotation direction of the jib support line connecting link 27 that is the direction in which the jib support line connecting link 27 is rotated away from the back surface (the jib back surface 6b) of the lower jib member 6A toward the back thereof in a state where the strut 26 takes the storage posture. The locked portion 55 has a hook shape.

The link pressing portion 56 is a portion that abuts on the strut support line connecting link 28 and presses the strut support line connecting link 28 so as to cause the strut support line connecting link 28 to take the strut support line connecting link fixed posture to be described later, when the jib support line connecting link 27 is rotated in the direction away from the back surface 6b of the lower jib member 6A toward the back thereof in a state where the strut 26 takes the storage posture. The link pressing portion 56 may have, for example, a round bar shape. The link pressing portion 56 may be bridged between the pair of side plates 52. Specifically, for example, the link pressing portion 56 may be bridged between the side edge of one side plate 52 and the side edge of the other side plate 52. The side edge may be, for example, a side edge facing the rotation direction of the jib support line connecting link 27 that is the direction in which the jib support line connecting link is rotated away from the back surface 6b of the lower jib member 6A toward the back thereof in a state where the strut 26 takes the storage posture. The link pressing portion 56 has a shape that can be fitted into a recessed portion 64 of a pressed portion 63 to be described later of the strut support line connecting link 28.

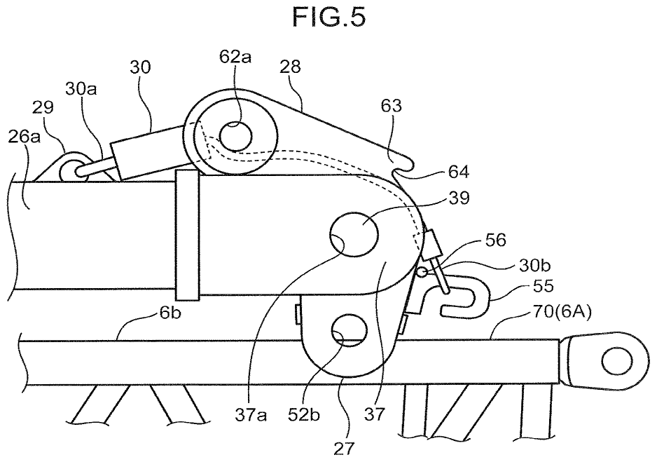

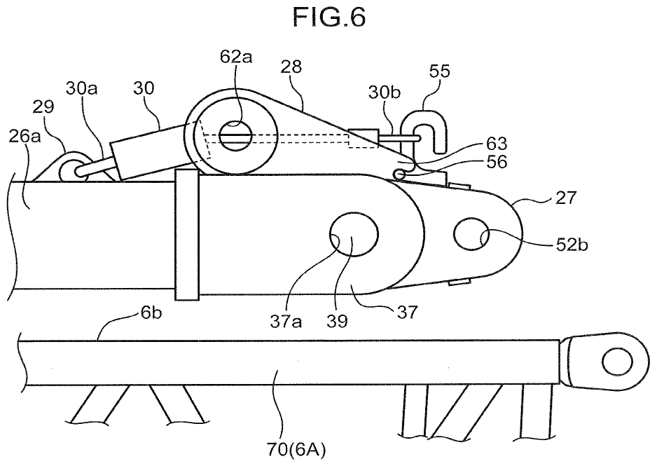

In a state where the lower jib member 6A is laid down, the strut 26 takes the storage posture, and the jib support line connecting link 27 is not restrained by the link restraint tool 30, as illustrated in FIG. 5, each jib support line connecting link 27 takes a rotation posture projecting downward from the strut distal end portion 37, and is disposed in such a manner that the line connection hole 52b overlaps the main column 70 on the back surface side of the lower jib member 6A when viewed from the direction along the rotation axis of the jib support line connecting link 27. On the other hand, when each of the jib support line connecting links 27 is restrained by the corresponding link restraint tool 30 as described later in a state where the strut 26 takes the storage posture, the jib support line connecting link 27 takes the jib support line connecting link fixed posture (see FIG. 6) that is the rotation posture in which the line connection hole 52b is disposed at a position away from the back surface 6b of the lower jib member 6A in the back thereof. As illustrated in FIG. 6, in a state where the lower jib member 6A of the jib 6 is laid down along the ground, the position away from the back surface 6b of the lower jib member 6A in the back thereof is a position away upward from the back surface 6b of the lower jib member 6A. As illustrated in FIG. 6, the jib support line connecting link fixed posture is the rotation posture of the jib support line connecting link 27 in a state where the link pressing portion 56 of the jib support line connecting link 27 presses the strut support line connecting link 28 and the strut support line connecting link 28 is received by the link receiving portion 26b of the strut body 26a.

Each of the pair of strut support line connecting links 28 is attached to the corresponding one of the pair of strut distal end portions 37 so as to be rotatable about an axis parallel to the rotation axis of the strut proximal end portion 36. Specifically, each of the pair of strut support line connecting links 28 is attached to the strut distal end portion 37 so as to be rotatable about the same axis as the rotation axis of the jib support line connecting link 27 attached to the strut distal end portion 37 to which the strut support line connecting link 28 is attached. Each strut support line connecting link 28 and the corresponding jib support line connecting link 27 are relatively rotatable. The strut support line one end portion 23a of each of the pair of strut support lines 23 is separably connected to each of the pair of strut support line connecting links 28.

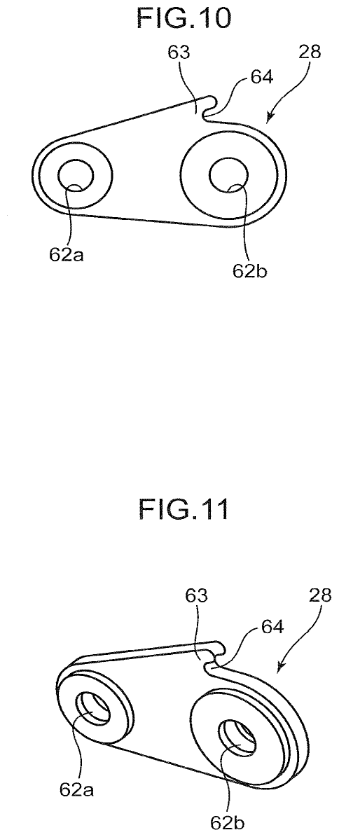

Each strut support line connecting link 28 is inserted into the gap between the pair of side plates 52 of the corresponding jib support line connecting link 27. Each strut support line connecting link 28 includes a shaft pin insertion hole 62b and a line connection hole 62a (see FIGS. 10 and 11).

The shaft pin 39 inserted into the insertion hole 37a of the strut distal end portion 37 and the shaft pin insertion hole 52a of the side plate 52 of the jib support line connecting link 27 is inserted into the shaft pin insertion hole 62b. The strut support line connecting link 28 is rotatable about the shaft pin 39 with respect the strut distal end portion 37. In addition, the strut support line connecting link 28 and the corresponding jib support line connecting link 27 are relatively rotatable about the shaft pin 39.

The line connection hole 62a is a portion to which the strut support line one end portion 23a is connected. Specifically, the connection pin 25 is inserted into the line connection hole 62a, and the strut support line one end portion 23a is connected to the strut support line connecting link 28 via the connection pin 25.

In addition, each strut support line connecting link 28 has the pressed portion 63 pressed by the link pressing portion 56 of the jib support line connecting link 27 when the corresponding jib support line connecting link 27 is rotated in the direction away from the back surface 6b of the lower jib member 6A toward the back thereof. As illustrated in FIG. 6, in a state where the lower jib member 6A of the jib 6 is laid down along the ground, the direction away from the back surface 6b of the lower jib member 6A toward the back thereof is a direction away upward from the back surface 6b of the lower jib member 6A. The pressed portion 63 has the recessed portion 64 capable of receiving the link pressing portion 56 approaching when the corresponding jib support line connecting link 27 is rotated in the direction described above.

Each strut support line connecting link 28 takes a strut support line connecting link fixed posture (see FIG. 6) that is a predetermined rotation posture when restrained by the corresponding link restraint tool 30 as described later. Specifically, each strut support line connecting link 28 is restrained in the strut support line connecting link fixed posture when the corresponding jib support line connecting link 27 is restrained in the jib support line connecting link fixed posture by the corresponding link restraint tool 30 and the strut support line connecting link 28 is pressed against the link receiving portion 26b by the link pressing portion 56 of the jib support line connecting link 27.

Each of the pair of link restraint tools 30 is configured to be capable of restraining the corresponding jib support line connecting link 27 with respect to the strut distal end portion 37 in the jib support line connecting link fixed posture and restraining the corresponding strut support line connecting link 28 with respect to the strut distal end portion 37 in the strut support line connecting link fixed posture. When the strut 26 and the lower jib member 6A are integrally transported, and when the jib support line other end portion 22b is attached to and detached from the jib support line connecting link 27 and the strut support line one end portion 23a is attached to and detached from the strut support line connecting link 28, the pair of link restraint tools 30 is used to restrain the jib support line connecting link 27 and the strut support line connecting link 28 in the individual fixed postures so as not to rotate the corresponding links 27 and 28.

In the present embodiment, each link restraint tool 30 is a fastener configured to be capable of connecting the restraint tool attachment portion 29 of the strut 26 and the jib support line connecting link 27, pulling the jib support line connecting link 27 in such a manner that the jib support line connecting link 27 rotates in the direction away from the back surface 6b of the lower jib member 6A toward the back thereof in a state where the strut 26 takes the storage posture, and fastening the jib support line connecting link in the jib support line connecting link fixed posture. More specifically, a chain block, which is an example of a fastener, is used as each link restraint tool 30.

Each link restraint tool 30 includes a fixed-side locking portion 30a attached to the corresponding restraint tool attachment portion 29, and the link-side locking portion 30b locked to the locked portion 55 of the corresponding jib support line connecting link 27. In a case where the link restraint tool 30 is a chain block as in the present embodiment, the fixed-side locking portion 30a is a hook coupled to the body of the chain block and is hooked and attached to the restraint tool attachment portion 29, and the link-side locking portion 30b is a hook connected to the body of the chain block via a chain and is hooked and locked to the locked portion 55 of the jib support line connecting link 27. The link restraint tool 30 is configured to be capable of pulling the link-side locking portion 30b in such a manner that the link-side locking portion 30b approaches the fixed-side locking portion 30a. That is, the link restraint tool 30 is configured to be capable of adjusting the length from the fixed-side locking portion 30a to the link-side locking portion 30b.

When the jib support line connecting link 27 is restrained by each link restraint tool 30, the fixed-side locking portion 30a is locked to the corresponding restraint tool attachment portion 29 and the link-side locking portion 30b is locked to the locked portion 55 of the corresponding jib support line connecting link 27. In this state, the link pressing portion 56 of the jib support line connecting link 27 abuts on the pressed portion 63 of the strut support line connecting link 28 and is fitted into the recessed portion 64 of the pressed portion 63, and the link-side locking portion 30b is pulled toward the fixed-side locking portion 30a until the strut support line connecting link 28 is received by the link receiving portion 26b. As a result, the jib support line connecting link 27 is fastened and restrained with respect to the restraint tool attachment portion 29 in the jib support line connecting link fixed posture by the link restraint tool 30, and the strut support line connecting link 28 is pressed against the link receiving portion 26b by the link pressing portion 56 of the jib support line connecting link 27 and restrained in the strut support line connecting link fixed posture.

The front stopper 31 is interposed between the strut 26 and the jib 6 in a state where the strut 26 takes a raised posture as illustrated in FIG. 1 to prevent the strut 26 from falling forward.

The back stopper 32 is interposed between the strut 26 and the boom distal end portion 15 in a state where the strut 26 takes a raised posture to prevent the strut 26 from falling rearward.

As illustrated in FIG. 1, the crane 100 to which the crane attachment 3 according to the present embodiment is applied further includes a boom raising-lowering device 110, a main winch 112, a main hook 113, an auxiliary winch 114, and an auxiliary hook 115.

The boom raising-lowering device 110 is a device that raises and lowers the boom 5. The boom raising-lowering device 110 includes a boom mast 118, a pendant rope 120, a mast-side sheave 122, a slewing body-side sheave (not illustrated), and a raising-lowering winch 124.

The boom mast 118 is used to raise and lower the boom 5, and is disposed at the rear of the boom 5. The boom mast 118 is attached to the slewing body 2 so as to be rotatable about an axis parallel to the rotation axis of the boom 5 (the rotation axis of the boom proximal end portion 14). Specifically, the boom mast 118 has a boom mast proximal end portion that is one end portion in a longitudinal direction thereof and a boom mast distal end portion 126 that is the opposite end portion thereof, and the boom mast proximal end portion is attached to the slewing body 2 so as to be rotatable about an axis parallel to the rotation axis of the boom 5. The boom mast 118 may be a so-called gantry.

The pendant rope 120 connects the boom mast distal end portion 126 and the boom distal end portion 15.

The mast-side sheave 122 is attached to the boom mast distal end portion 126 so as to be rotatable about an axis extending in parallel with the rotation axis of the boom mast proximal end portion.

The slewing body-side sheave (not illustrated) is attached to the back end portion of the slewing body 2 so as to be rotatable about an axis extending in the left-right direction of the slewing body 2.

The raising-lowering winch 124 is mounted on the slewing body 2, and winds up and pays out the raising-lowering rope 128 to raise and lower the boom 5. The raising-lowering winch 124 includes a raising-lowering drum around which the raising-lowering rope 128 is wound. The raising-lowering rope 128 is pulled out from the raising-lowering drum and wound around the mast-side sheave 122 and the slewing body-side sheave (not illustrated). The raising-lowering winch 124 rotates the raising-lowering drum forward to wind up the raising-lowering rope 128, thereby pulling the mast-side sheave 122 toward the slewing body-side sheave and rotating the boom mast 118 rearward, so that the boom mast 118 pulls the boom distal end portion 15 rearward via the pendant rope 120 to raise the boom 5. On the other hand, the raising-lowering winch 124 reversely rotates the raising-lowering drum to pay out the raising-lowering rope 128, thereby allowing the boom mast 118 to rotate forward, so that the boom 5 is laid down while the boom mast 118 supports the boom distal end portion 15 via the pendant rope 120.

The main winch 112 winds up and pays out the main rope 132 to lift and lower the main hook 113 suspended from the jib distal end portion 18 via the main rope 132.

The auxiliary winch 114 winds up and pays out the auxiliary rope 134 to lift and lower the auxiliary hook 115 suspended from the boom distal end portion 15 via the auxiliary rope 134.

Next, a method of assembling the crane attachment 3 according to the present embodiment will be described.

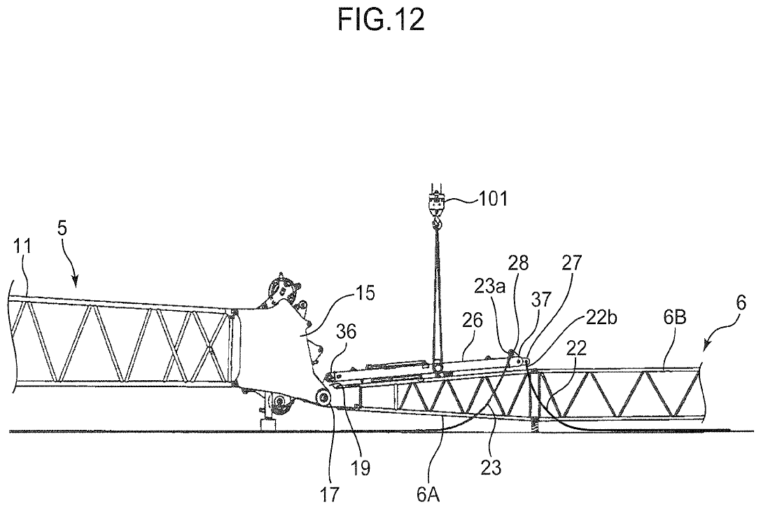

In this assembling method, the boom proximal end portion 14 is coupled to the slewing body 2 in a state where the boom 5 is laid down. As illustrated in FIG. 12, the jib proximal end portion 17 of the lower jib member 6A is coupled to the boom distal end portion 15 of the boom 5, the intermediate jib member 6B is coupled to the lower jib member 6A, and although not illustrated in FIG. 12, the upper jib member 6C is coupled to the intermediate jib member 6B.

The jib 6 including the lower jib member 6A, the intermediate jib member 6B, and the upper jib member 6C is disposed so as to extend in a state of being laid down forward from the boom distal end portion 15.

At this time, the strut 26 is disposed in a storage posture along the back surface 6b of the lower jib member 6A. Each jib support line connecting link 27 and each strut support line connecting link 28 of the strut 26 are restrained in the individual fixed postures by the corresponding link restraint tool 30 (see FIGS. 3 and 6). In this state, the jib support line other end portion 22b of the corresponding jib support line 22 is connected to each jib support line connecting link 27, and the strut support line one end portion 23a of the corresponding strut support line 23 is connected to each strut support line connecting link 28.

Specifically, the connection pin 24 is inserted into the line connection hole 52b of each jib support line connecting link 27, and the jib support line other end portion 22b is connected to the jib support line connecting link 27 via the connection pin 24. In addition, the connection pin 25 is inserted into the line connection hole 62a of each strut support line connecting link 28, and the strut support line one end portion 23a is connected to the strut support line connecting link 28 via the connection pin 25.

Thereafter, the restraint of each jib support line connecting link 27 by each link restraint tool 30 is released. As a result, each jib support line connecting link 27 becomes rotatable with respect to the strut distal end portion 37, and at the same time, each strut support line connecting link 28 pressed and fixed by the link pressing portion 56 of each jib support line connecting link 27 also becomes rotatable with respect to the strut distal end portion 37.

Thereafter, the jib support line one end portion 22a of each jib support line 22 is coupled to the jib-side line coupling portion 18a of the jib distal end portion 18, and the strut support line other end portion 23b of each strut support line 23 is coupled to the boom-side line coupling portion 12 of the boom 5.

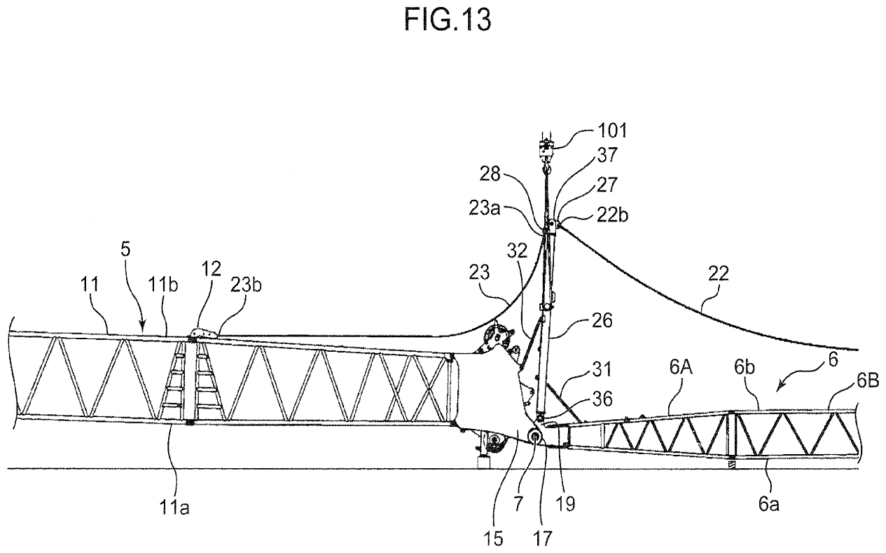

Thereafter, as illustrated in FIGS. 12 and 13, the strut 26 is raised from the storage posture to the raised posture by an auxiliary crane 101. Next, the front stopper 31 is interposed between the lower jib member 6A and the strut 26, and the back stopper 32 is interposed between the boom distal end portion 15 and the strut 26.

Thereafter, the boom 5 is raised by the boom raising-lowering device 110.

The crane attachment 3 according to the present embodiment is assembled as described above. Note that the disassembly of the crane attachment 3 according to the present embodiment is performed by a procedure reverse to that of the above assembly.

In the crane attachment 3 according to the present embodiment, the jib support device 8 has the link restraint tool 30 configured to be capable of restraining the jib support line connecting link 27 in the jib support line connecting link fixed posture and restraining the strut support line connecting link 28 in the strut support line connecting link fixed posture. Therefore, during the assembly, disassembly, and transportation of the crane 100 to which the crane attachment 3 is applied, the link restraint tool 30 restrains the jib support line connecting link 27 in the jib support line connecting link fixed posture and restrains the strut support line connecting link 28 in the strut support line connecting link fixed posture, so that it is possible to prevent the links 27 and 28 from unintentionally rotating. As a result, it is possible to prevent the jib support line connecting link 27 and the strut support line connecting link 28 from colliding with a surrounding member or the like and being damaged during the assembly, disassembly, and transportation of the crane 100.

In addition, at the time of attaching and detaching the jib support line 22 to and from the jib support line connecting link 27 and at the time of attaching and detaching the strut support line 23 to and from the strut support line connecting link 28, the jib support line connecting link 27 is restrained in the jib support line connecting link fixed posture and the strut support line connecting link 28 is restrained in the strut support line connecting link fixed posture by the link restraint tool 30, so that the jib support line 22 and the strut support line 23 can be attached and detached in a state where the links 27 and 28 do not move. As a result, it is possible to improve the workability of attaching and detaching the jib support line 22 to and from the jib support line connecting link 27 and of attaching and detaching the strut support line 23 to and from the strut support line connecting link 28.

Therefore, in the crane attachment 3 according to the present embodiment, it is possible to prevent the jib support line connecting link 27 and the strut support line connecting link 28 from being damaged during the disassembly, assembly, and transportation of the crane 100, and it is possible to improve the workability of attaching and detaching the jib support line 22 to and from the jib support line connecting link 27 and attaching and detaching the strut support line 23 to and from the strut support line connecting link 28.

In addition, in the crane attachment 3 according to the present embodiment, the strut proximal end portion 36 is rotatably attached to the strut support portion 19 of the jib proximal end portion 17, and the strut 26 is configured to be capable of taking a storage posture that is a rotation posture about the rotation axis of the strut proximal end portion 36, in which the strut 26 is disposed along the lower jib member 6A. Therefore, the strut 26 can take the storage posture in a state where the strut proximal end portion 36 is attached to the jib proximal end portion 17, and the strut 26 can be loaded and transported on a transport vehicle integrally with the lower jib member 6A.

Furthermore, in the present embodiment, the jib support line connecting link fixed posture is a posture in which the line connection hole 52b of the jib support line connecting link 27 is disposed at a position away from the back surface 6b of the lower jib member 6A in the back thereof when the strut 26 takes the storage posture. Therefore, when the jib support line other end portion 22b is attached to and detached from the line connection hole 52b of the jib support line connecting link 27 via the connection pin 24 in a state where the strut 26 takes the storage posture, the attachment and detachment of the jib support line other end portion 22b can be performed (the connection pin 24 can be inserted into and removed from the line connection hole 52b) at a position away from the lower jib member 6A in the back thereof. As a result, the workability of attaching and detaching the jib support line other end portion 22b can be improved.

In addition, in the present embodiment, the jib support line connecting link 27 has the link pressing portion 56 that abuts on the strut support line connecting link 28 and presses the strut support line connecting link 28 so as to cause the strut support line connecting link 28 to take the strut support line connecting link fixed posture, when the jib support line connecting link 27 is rotated in the direction away from the back surface 6b of the lower jib member 6A toward the back thereof in a state where the strut 26 takes the storage posture. Therefore, only by rotating the jib support line connecting link 27 in the direction away from the back surface 6b of the lower jib member 6A toward the back thereof in order to cause the jib support line connecting link 27 to take the jib support line connecting link fixed posture, the strut support line connecting link 28 can be pressed by the link pressing portion 56 of the jib support line connecting link 27 to be directed to the strut support line connecting link fixed posture. Therefore, the work of arranging the jib support line connecting link 27 and the strut support line connecting link 28 in the individual fixed postures can be simplified.

Furthermore, in the present embodiment, the jib support line connecting link fixed posture is the rotation posture of the jib support line connecting link 27 in a state where the link pressing portion 56 of the jib support line connecting link 27 presses the strut support line connecting link 28 and the strut support line connecting link 28 is received by the link receiving portion 26b of the strut body 26a. Therefore, by rotating the jib support line connecting link 27 until the strut support line connecting link 28 is received by the link receiving portion 26b and pressing the strut support line connecting link 28 by the link pressing portion 56, the strut support line connecting link 28 can be disposed in the strut support line connecting link fixed posture and the jib support line connecting link 27 can be disposed in the jib support line connecting link fixed posture. As a result, the worker can perform the work of arranging the strut support line connecting link 28 and the jib support line connecting link 27 in the individual fixed postures without particularly paying attention to whether the rotation posture of the strut support line connecting link 28 has reached the strut support line connecting link fixed posture and whether the rotation posture of the jib support line connecting link 27 has reached the jib support line connecting link fixed posture, so that the work load of the worker can be reduced.

Furthermore, in the present embodiment, the pressed portion 63 of the strut support line connecting link 28 has the recessed portion 64, and the link pressing portion 56 of the jib support line connecting link 27 has a round bar shape that can be fitted into the recessed portion 64. Therefore, when the link pressing portion 56 of the jib support line connecting link 27 presses the pressed portion 63 of the strut support line connecting link 28, the stability of the state where the link pressing portion 56 presses the pressed portion 63 of the strut support line connecting link 28 can be enhanced by the fitting between the recessed portion 64 of the pressed portion 63 and the link pressing portion 56.

Furthermore, in the present embodiment, the link restraint tool 30 is a fastener configured to be capable of connecting a predetermined portion of the strut 26 and the jib support line connecting link 27, pulling the jib support line connecting link 27 in such a manner that the jib support line connecting link 27 rotates in the direction away from the back surface 6b of the lower jib member 6A toward the back thereof in a state where the strut 26 takes the storage posture, and fastening the jib support line connecting link in the jib support line connecting link fixed posture. The predetermined portion of the strut 26 is a portion between the strut proximal end portion 36 and the strut distal end portion 37. In the present embodiment, the predetermined portion of the strut 26 is a portion of the strut 26 shifted to be closer to the strut proximal end portion 36 than the strut distal end portion 37. Therefore, only by pulling the jib support line connecting link 27 by the link restraint tool 30 (fastener) until the link pressing portion 56 of the jib support line connecting link 27 presses the strut support line connecting link 28 and the strut support line connecting link 28 is received by the link receiving portion 26b of the strut body 26a, the strut support line connecting link 28 and the jib support line connecting link 27 can be arranged in the individual fixed postures and the same time, can be restrained in the individual fixed postures. As a result, the work load can be reduced as compared with the case where the work of rotating the strut support line connecting link 28 and the jib support line connecting link 27 to the individual fixed postures and the work of restraining the links 28 and 27 in the individual fixed postures are separately performed.

### Modifications

The crane attachment according to the present invention is not necessarily limited to the above configuration. For the crane attachment according to the present invention, for example, the following technique can be adopted.

(1) The link restraint tool is not necessarily limited to the fastener such as the chain block used in the above embodiment as long as the rotation posture of the jib support line connecting link with respect to the strut distal end portion can be restrained in the jib support line connecting link fixed posture, and the rotation posture of the strut support line connecting link with respect to the strut distal end portion can be restrained in the strut support line connecting link fixed posture. For example, the link restraint tool may be a fixing pin that pins the jib support line connecting link disposed in the jib support line connecting link fixed posture and the strut support line connecting link disposed in the strut support line connecting link fixed posture to the strut distal end portion. In this case, the strut distal end portion is only required to have an insertion hole through which a fixing pin is inserted when the jib support line connecting link and the strut support line connecting link are restrained, and the jib support line connecting link and the strut support line connecting link are only required to have an insertion hole that overlaps the insertion hole of the strut distal end portion when arranged in the individual fixed postures and through which the fixing pin inserted.

(2) In addition, even in a case where the link restraint tool is a fastener, the fastener is not necessarily limited to a chain block, and may be a cable-like member such as a sling or a rope, and a predetermined portion of the strut and the jib support line connecting link are connected by such a cable-like member and the jib support line connecting link may be fastened in the jib support line connecting link fixed posture.

(3) The crane attachment according to the present invention may be not only a fixed jib type in which the angle of the jib with respect to the boom is fixed but also a luffing jib type in which the angle of the jib with respect to the boom is changeable.

(4) In addition, the attached portion to which the strut is attached, more specifically, the attached portion to which the strut proximal end portion is attached may be the boom distal end portion instead of the jib proximal end portion. In this case, when the jib takes the forward tilted posture, the strut is disposed in a posture extending from the boom distal end portion to the back thereof in a state of being attached to the boom distal end portion, and holds the jib support line connecting link and the strut support line connecting link at positions away from the boom distal end portion in the back thereof.

Furthermore, in this case, at the time of transportation of the crane, the strut may be removed from the boom distal end portion, disposed in the storage posture along the lower jib member, and transported integrally with the lower jib member. Alternatively, the strut may be removed from the boom distal end portion and transported alone. In a case where the strut is transported alone, at the time of assembling the crane (at the time of assembling the crane attachment), the strut proximal end portion is attached to the boom distal end portion of the laid down boom while the strut is suspended by the auxiliary crane, and then the strut is placed along the lower jib member in a state of being coupled to the boom distal end portion and laid down so as to extend forward from the boom distal end portion. Thereafter, it is only required that the crane attachment is assembled in a process similar to the process after the connection of the jib support line other end portion to the jib support line connecting link and the connection of the strut support line one end portion to the strut support line connecting link in the method of assembling the crane attachment according to the embodiment.

As described above, according to the present invention, there is provided a crane attachment capable of preventing a jib support line connecting link and a strut support line connecting link from being damaged during the disassembly, assembly, and transportation of a crane, and capable of improving the workability of attaching and detaching a jib support line to and from the jib support line connecting link and attaching and detaching a strut support line to and from the strut support line connecting link.

Provided by the present invention is a crane attachment for performing crane work of hanging a suspended load by being attached to a crane body. The crane attachment includes a boom that has a boom proximal end portion attached to the crane body and a boom distal end portion that is an end portion opposite to the boom proximal end portion, a jib that has a jib proximal end portion that is one end portion rotatable about an axis extending in a width direction of the boom with respect to the boom distal end portion and separably attached to the boom distal end portion, and a jib distal end portion that is an end portion opposite to the jib proximal end portion, and a jib support device that supports, from rear, the jib that takes a forward tilted posture with respect to the boom when the boom proximal end portion is attached to the crane body and the boom takes a raised posture. The jib support device includes a jib support line that has a jib support line one end portion that is an end portion connected to the jib distal end portion and a jib support line other end portion that is an end portion opposite to the jib support line one end portion, a strut that is attached to an attached portion that is one of the jib proximal end portion or the boom distal end portion, is disposed in a posture extending from the attached portion to back of the attached portion when the jib takes the forward tilted posture, and supports the jib support line other end portion at a position away from the attached portion to the back of the attached portion so as to cause the jib support line to extend from the jib distal end portion and be stretched, and a strut support line that has a strut support line one end portion connected to the strut and keeps the strut from falling down in a direction along the jib. The strut includes a strut body that has a strut proximal end portion that is one end portion attached to the attached portion so as to be rotatable about an axis parallel to a rotation axis of the jib proximal end portion and a strut distal end portion that is an end portion opposite to the strut proximal end portion, a jib support line connecting link that is attached to the strut distal end portion so as to be rotatable about an axis parallel to a rotation axis of the strut proximal end portion and to which the jib support line other end portion is connected, and a strut support line connecting link that is attached to the strut distal end portion so as to be rotatable about an axis parallel to the rotation axis of the strut proximal end portion and to which the strut support line one end portion is connected. The jib support device further includes a link restraint tool configured to be capable of restraining the jib support line connecting link in a jib support line connecting link fixed posture that is a predetermined rotation posture with respect to the strut distal end portion and restraining the strut support line connecting link in a strut support line connecting link fixed posture that is a predetermined rotation posture with respect to the strut distal end portion.

In this crane attachment, since the jib support device includes the link restraint tool configured to be capable of restraining the jib support line connecting link in the jib support line connecting link fixed posture and restraining the strut support line connecting link in the strut support line connecting link fixed posture, during the assembly, disassembly, and transportation of the crane to which the crane attachment is applied, the jib support line connecting link is restrained in the jib support line connecting link fixed posture and the strut support line connecting link is restrained in the strut support line connecting link fixed posture by the link restraint tool, so that it is possible to prevent these links from unintentionally rotating. As a result, it is possible to prevent the jib support line connecting link and the strut support line connecting link from colliding with a surrounding member or the like and being damaged during the assembly, disassembly, and transportation of the crane.

In addition, at the time of attaching and detaching the jib support line to and from the jib support line connecting link and at the time of attaching and detaching the strut support line to and from the strut support line connecting link, the jib support line connecting link is restrained in the jib support line connecting link fixed posture and the strut support line connecting link is restrained in the strut support line connecting link fixed posture by the link restraint tool, so that the jib support line and the strut support line can be attached and detached in a state where these links do not move. As a result, it is possible to improve the workability of attaching and detaching the jib support line to and from the jib support line connecting link and of attaching and detaching the strut support line to and from the strut support line connecting link.

Therefore, in this crane attachment, it is possible to prevent the jib support line connecting link and the strut support line connecting link from being damaged during the disassembly, assembly, and transportation of the crane, and it is possible to improve the workability of attaching and detaching the jib support line to and from the jib support line connecting link and attaching and detaching the strut support line to and from the strut support line connecting link.

Preferably, the jib includes a plurality of jib members arranged side by side in an extending direction of the jib and separably coupled to each other, the plurality of jib members include a lower jib member that is a jib member having the jib proximal end portion, and the strut is configured to be capable of taking a storage posture that is a rotation posture around a rotation axis of the strut proximal end portion in which the strut is disposed along a back surface of the lower jib member.

According to this configuration, the strut can take the storage posture in a state where the strut proximal end portion is attached to the jib proximal end portion, and the strut can be loaded and transported on a transport vehicle integrally with the lower jib member.

Preferably, the jib support line connecting link includes a line connection portion to which the jib support line other end portion is connected, and the jib support line connecting link fixed posture is a posture in which the line connection portion is disposed at a position away from the lower jib member when the strut takes the storage posture. That is, the jib support line connecting link fixed posture is preferably a posture in which the line connection portion is disposed at a position away from the back surface of the lower jib member in the back thereof when the strut takes the storage posture.

According to this configuration, when the jib support line other end portion is attached to and detached from the line connection portion of the jib support line connecting link in a state where the strut takes the storage posture, the attachment and detachment of the jib support line other end portion can be performed at a position away from the back surface of the lower jib member in the back thereof and not interfered by the lower jib member, so that the workability of attaching and detaching the jib support line other end portion can be improved.

The jib support line connecting link preferably includes a link pressing portion that abuts on the strut support line connecting link and presses the strut support line connecting link so as to cause the strut support line connecting link to take the strut support line connecting link fixed posture, when the jib support line connecting link is rotated in a direction away from the lower jib member in a state where the strut takes the storage posture. The direction in which the jib support line connecting link is moved away from the lower jib member is a direction in which the jib support line connecting link is moved away from the back surface of the lower jib member toward the back thereof.

According to this configuration, only by rotating the jib support line connecting link in the direction away from the back surface of the lower jib member toward the back thereof in order to cause the jib support line connecting link to take the jib support line connecting link fixed posture, the strut support line connecting link can be pressed by the link pressing portion of the jib support line connecting link to be directed to the strut support line connecting link fixed posture. Therefore, the work of causing the jib support line connecting link to take the jib support line connecting link fixed posture and causing the strut support line connecting link to take the strut support line connecting link fixed posture can be simplified.

Preferably, the strut body includes a link receiving portion that receives the strut support line connecting link when the strut support line connecting link is pressed by the link pressing portion and disposed in the strut support line connecting link fixed posture, and the jib support line connecting link fixed posture is a rotation posture of the jib support line connecting link in a state where the link pressing portion of the jib support line connecting link presses the strut support line connecting link and the strut support line connecting link is received by the link receiving portion.

According to this configuration, by rotating the jib support line connecting link until the strut support line connecting link is received by the link receiving portion and presses the strut support line connecting link by the link pressing portion, the strut support line connecting link can be disposed in the strut support line connecting link fixed posture and the jib support line connecting link can be disposed in the jib support line connecting link fixed posture. As a result, the worker can perform the work of arranging the strut support line connecting link and the jib support line connecting link in the individual fixed postures without particularly paying attention to whether the rotation posture of the strut support line connecting link has reached the strut support line connecting link fixed posture and whether the rotation posture of the jib support line connecting link has reached the jib support line connecting link fixed posture, so that the work load of the worker can be reduced.

Preferably, the strut support line connecting link includes a pressed portion pressed by the link pressing portion when the jib support line connecting link is rotated in a direction away from the lower jib member, and one of the link pressing portion or the pressed portion includes a recessed portion capable of receiving the other of the link pressing portion or the pressed portion, the other of the link pressing portion or the pressed portion having a shape capable of fitting into the recessed portion. The direction in which the jib support line connecting link is moved away from the lower jib member is a direction in which the jib support line connecting link is moved away from the back surface of the lower jib member toward the back thereof.

According to this configuration, when the link pressing portion of the jib support line connecting link presses the pressed portion of the strut support line connecting link, the stability of the state where the link pressing portion presses the strut support line connecting link can be enhanced by the fitting between the recessed portion of one of the link pressing portion or the pressed portion and the other one.

The link restraint tool is preferably a fastener configured to be capable of connecting a predetermined portion of the strut and the jib support line connecting link, pulling the jib support line connecting link so as to rotate the jib support line connecting link in a direction away from the lower jib member in a state where the strut takes the storage posture, and fastening the jib support line connecting link in the jib support line connecting link fixed posture. The direction in which the jib support line connecting link is moved away from the lower jib member is a direction in which the jib support line connecting link is moved away from the back surface of the lower jib member toward the back thereof.

According to this configuration, only by pulling the jib support line connecting link by the fastener until the link pressing portion of the jib support line connecting link presses the strut support line connecting link and the strut support line connecting link is received by the link receiving portion, the strut support line connecting link and the jib support line connecting link can be arranged in the individual fixed postures and the same time, can be restrained in the individual fixed postures. As a result, the work load can be reduced as compared with the case where the work of rotating the strut support line connecting link and the jib support line connecting link to the individual fixed postures and the work of restraining these links in the individual fixed postures are separately performed.

1. A crane attachment for performing crane work of hanging a suspended load by being attached to a crane body, the crane attachment comprising:
a boom that has a boom proximal end portion attached to the crane body and a boom distal end portion that is an end portion opposite to the boom proximal end portion;
a jib that has a jib proximal end portion that is one end portion rotatable about an axis extending in a width direction of the boom with respect to the boom distal end portion and separably attached to the boom distal end portion, and a jib distal end portion that is an end portion opposite to the jib proximal end portion; and
a jib support device that supports, from rear, the jib that takes a forward tilted posture with respect to the boom when the boom proximal end portion is attached to the crane body and the boom takes a raised posture,
wherein the jib support device includes a jib support line that has a jib support line one end portion that is an end portion connected to the jib distal end portion and a jib support line other end portion that is an end portion opposite to the jib support line one end portion, a strut that is attached to an attached portion that is one of the jib proximal end portion or the boom distal end portion, is disposed in a posture extending from the attached portion to back of the attached portion when the jib takes the forward tilted posture, and supports the jib support line other end portion at a position away from the attached portion to the back of the attached portion so as to cause the jib support line to extend from the jib distal end portion and be stretched, and a strut support line that has a strut support line one end portion connected to the strut and keeps the strut from falling down in a direction along the jib,
the strut includes a strut body that has a strut proximal end portion that is one end portion attached to the attached portion so as to be rotatable about an axis parallel to a rotation axis of the jib proximal end portion and a strut distal end portion that is an end portion opposite to the strut proximal end portion, a jib support line connecting link that is attached to the strut distal end portion so as to be rotatable about an axis parallel to a rotation axis of the strut proximal end portion and to which the jib support line other end portion is connected, and a strut support line connecting link that is attached to the strut distal end portion so as to be rotatable about an axis parallel to the rotation axis of the strut proximal end portion and to which the strut support line one end portion is connected, and
the jib support device further includes a link restraint tool configured to be capable of restraining the jib support line connecting link in a jib support line connecting link fixed posture that is a predetermined rotation posture with respect to the strut distal end portion and restraining the strut support line connecting link in a strut support line connecting link fixed posture that is a predetermined rotation posture with respect to the strut distal end portion.

2. The crane attachment according to claim 1, wherein
the jib includes a plurality of jib members arranged side by side in an extending direction of the jib and separably coupled to each other,
the plurality of jib members include a lower jib member that is a jib member having the jib proximal end portion, and
the strut is configured to be capable of taking a storage posture that is a rotation posture around a rotation axis of the strut proximal end portion in which the strut is disposed along a back surface of the lower jib member.

3. The crane attachment according to claim 2, wherein
the jib support line connecting link includes a line connection portion to which the jib support line other end portion is connected, and
the jib support line connecting link fixed posture is a posture in which the line connection portion is disposed at a position away from the lower jib member when the strut takes the storage posture.

4. The crane attachment according to claim 2, wherein the jib support line connecting link includes a link pressing portion that abuts on the strut support line connecting link and presses the strut support line connecting link so as to cause the strut support line connecting link to take the strut support line connecting link fixed posture, when the jib support line connecting link is rotated in a direction away from the lower jib member in a state where the strut takes the storage posture.

5. The crane attachment according to claim 4, wherein
the strut body includes a link receiving portion that receives the strut support line connecting link when the strut support line connecting link is pressed by the link pressing portion and disposed in the strut support line connecting link fixed posture, and
the jib support line connecting link fixed posture is a rotation posture of the jib support line connecting link in a state where the link pressing portion of the jib support line connecting link presses the strut support line connecting link and the strut support line connecting link is received by the link receiving portion.

6. The crane attachment according to claim 5, wherein
the strut support line connecting link includes a pressed portion pressed by the link pressing portion when the jib support line connecting link is rotated in a direction away from the lower jib member, and
one of the link pressing portion or the pressed portion includes a recessed portion capable of receiving the other of the link pressing portion or the pressed portion, the other of the link pressing portion or the pressed portion having a shape capable of fitting into the recessed portion.

7. The crane attachment according to claim 4, wherein the link restraint tool is a fastener configured to be capable of connecting a predetermined portion of the strut and the jib support line connecting link, pulling the jib support line connecting link so as to rotate the jib support line connecting link in a direction away from the lower jib member in a state where the strut takes the storage posture, and fastening the jib support line connecting link in the jib support line connecting link fixed posture.
